(19) United States
(12) Patent Application Publication
(10) Pub. No.: US 2024/0104580 A1
(43) Pub. Date: Mar. 28, 2024

(54) SERVICE LEVEL AGREEMENT MANAGEMENT AND BREACH DETECTION

(71) Applicant: Capital One Services, LLC, McLean, VA (US)

(72) Inventors: Sridhar Reddy MEKALA, Naperville, IL (US); Matthew ROSENBAUM, Chicago, IL (US)

(21) Appl. No.: 17/935,794

(22) Filed: Sep. 27, 2022

(51) Int. Cl. G06Q 30/00; G06F 16/25; G06Q 10/06

(52) U.S. Cl. CPC G06Q 30/018; G06F 16/254; G06Q 10/06

(57) ABSTRACT

In some implementations, a system may identify a set of data processing jobs to track for SLA compliance. The system may trigger a step function for each data processing job tracked for SLA compliance, wherein the step function associated with each data processing job includes a wait time based on a time when an SLA associated with the respective data processing job must be satisfied. The system may determine whether information indicating a success state for each data processing job is available in a storage location. The system may send one or more messages for one or more data processing jobs in the set of data processing jobs that are associated with an SLA breach, wherein the one or more data processing jobs are identified based on determining that information indicating the success state for the one or more data processing jobs is not present in the storage location.

### BACKGROUND

In information technology, a service level agreement (SLA) is a commitment between a service provider (e.g., a technology vendor that provides a service) and a client (e.g., a user or other consumer of the service). For example, an SLA typically defines a level of service that the service provider is committed to providing (or that the client expects from the service provider) and/or provides one or more parameters to define technical metrics for measuring the level of service and/or the remedies or penalties, if any, that are triggered should the agreed-upon service levels not be achieved. SLAs are often made between organizations that are consuming a service and external vendors that are providing the service, although SLAs can also be defined between entities within an organization (e.g., between different departments). For example, in an SLA between a telecom company and an internet service provider, the SLA may specify that the telecom company promises to provide a certain network availability metric, mean time between failures, mean time to repair, mean time to recovery, minimum or average throughput, maximum jitter, and/or other measurable parameters, and/or may specify that the internet service provider is allowed to reduce payment by a given amount (e.g., a percentage, which may be on a sliding scale) in the event that the telecom company breaches the SLA.

### SUMMARY

Some implementations described herein relate to a system for service level agreement (SLA) management and breach detection. The system may include one or more memories and one or more processors communicatively coupled to the one or more memories. The one or more processors may be configured to configure a workflow management system to monitor a plurality of data processing jobs and to write, for each data processing job in the plurality of data processing jobs that completes successfully, information that indicates a success state for the respective data processing job to a designated storage location. The one or more processors may be configured to identify, at a scheduled time, a set of data processing jobs included among the plurality of data processing jobs to be tracked for SLA compliance. The one or more processors may be configured to trigger a step function for each data processing job in the set of data processing jobs to be tracked for SLA compliance. The one or more processors may be configured to determine, when the wait time of the step function associated with each respective data processing job has elapsed, whether the information that indicates the success state for each respective data processing job is available in the designated storage location. The one or more processors may be configured to render a user interface that indicates one or more of SLA compliance information or SLA breach information associated with each data processing job tracked for SLA compliance based on whether the information that indicates the success state for each respective data processing job is present in the designated storage location. The one or more processors may be configured to send one or more messages for one or more data processing jobs in the set of data processing jobs that are associated with an SLA breach.

Some implementations described herein relate to a method for tracking SLA compliance. The method may include identifying, by an SLA management system at a scheduled time, a set of data processing jobs to be tracked for SLA compliance. The method may include triggering, by the SLA management system, a step function for each data processing job in the set of data processing jobs to be tracked for SLA compliance, where the step function associated with each data processing job includes a wait time that is based on the scheduled time and a time when an SLA associated with the respective data processing job is to be satisfied. The method may include determining, by the SLA management system when the wait time of the step function associated with each respective data processing job has elapsed, whether information that indicates a success state for each respective data processing job is available in a designated storage location. The method may include sending, by the SLA management system, one or more messages for one or more data processing jobs in the set of data processing jobs that are associated with an SLA breach, where the one or more data processing jobs are identified based on the information that indicates the success state for the one or more data processing jobs not being present in the designated storage location.

Some implementations described herein relate to a non-transitory computer-readable medium that stores a set of instructions for an SLA management system. The set of instructions, when executed by one or more processors of the SLA management system, may cause the SLA management system to identify, at a scheduled time, a set of data processing jobs to be tracked for SLA compliance. The set of instructions, when executed by one or more processors of the SLA management system, may cause the SLA management system to trigger a step function for each data processing job in the set of data processing jobs to be tracked for SLA compliance. The set of instructions, when executed by one or more processors of the SLA management system, may cause the SLA management system to determine, when the wait time of the step function associated with each respective data processing job has elapsed, whether information that indicates a success state for each respective data processing job is available in a designated storage location. The set of instructions, when executed by one or more processors of the SLA management system, may cause the SLA management system to render a user interface that indicates one or more of SLA compliance information or SLA breach information associated with each data processing job tracked for SLA compliance based on whether the information that indicates the success state for each respective data processing job is present in the designated storage location.

### BRIEF DESCRIPTION OF THE DRAWINGS

FIG. 1 is a diagram of an example implementation associated with service level agreement (SLA) management and breach detection, in accordance with some embodiments of the present disclosure.

FIG. 2 is a diagram illustrating an example of training and using a machine learning model in connection with SLA management and breach detection, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process associated with SLA management and breach detection, in accordance with some embodiments of the present disclosure.

### DETAILED DESCRIPTION

The following detailed description of example implementations refers to the accompanying drawings. The same reference numbers in different drawings may identify the same or similar elements.

Data processing is a form of information processing in which data is collected, manipulated, modified, or otherwise processed to produce meaningful information. For example, a data processing job may involve processes that relate to data validation (e.g., ensuring that supplied data is correct and relevant), data sorting (e.g., arranging data items in a particular sequence and/or in different data sets), data summarization (e.g., reducing detailed data to main points), data aggregation (e.g., combining multiple data items), data analysis (e.g., collecting, organizing, analyzing, interpreting, and/or presenting data), data reporting (e.g., listing detailed or summarized data or computed information), and/or data classification (e.g., separating data into different categories). In some cases, a data processing system (e.g., a datacenter) may be configured to run or otherwise execute numerous data processing jobs according to a batch schedule, where each data processing job may include a data pipeline with upstream dependencies and downstream dependencies. For example, upstream dependencies associated with a data processing job may include other data processing jobs or tasks that need to complete before the data processing job can commence, and the downstream dependencies may include other data processing jobs or tasks that operate on the data output by the data processing job and/or downstream users that may need to interact with or otherwise consume the data output by the data processing job. Accordingly, in some cases, each stage in the data pipeline associated with a data processing job may be associated with a designated service level agreement (SLA) that must be satisfied, where the SLA may indicate a time or other parameters that specify when the data output by the data processing job needs to be available. In cases where the designated SLA is satisfied at each stage in the data processing pipeline, the appropriate output may be provided to downstream data processing jobs and/or downstream consumers of the data processing job in a timely manner.

However, in some cases, one or more stages in a data processing pipeline may fail to satisfy an associated SLA, which can lead to delays in providing the appropriate output to downstream data processing jobs and/or downstream consumers of the data processing job (which can in turn lead to the downstream data processing jobs failing to start on time). Accordingly, due to the upstream dependencies and/or other factors that may cause a delay in one or more stages in a data processing pipeline, the delayed stage(s) in the data processing pipeline may not start on time and the associated SLA may be breached. In some cases, the SLA breach may then lead to further delays and inefficiencies in the data processing pipeline. For example, many data processing jobs may be scheduled to execute at periodic intervals during off-hours or other times when there are few active users consuming resources within a datacenter (e.g., data processing jobs may be scheduled to run overnight, such as daily at midnight or 2 am, when most users are asleep and not actively working in the datacenter), and the data processing jobs may be associated with respective SLAs to ensure that the scheduled data processing job(s) complete before a time when there is an expected increase in user activity and/or a time when the output from the data processing job(s) is needed (e.g., the data processing jobs may be scheduled to complete before 8 am or another suitable time when users typically start a workday).

However, existing techniques to monitor data processing jobs for SLA compliance suffer from various drawbacks. For example, one technique to monitor data processing jobs is to use a workflow management system that can wait for an upstream dependency associated with a data processing job to be satisfied for a certain time period, after which the SLA is declared to be breached and the entire data processing job is failed to acknowledge the SLA breach. For example, a workflow management system may be configured to wait two (2) hours to receive a file or other suitable output from an upstream dependency (e.g., an external system or a relational system), where a data processing job may be triggered (e.g., start to execute) when the upstream dependency is satisfied so that the data processing job can deliver its output to downstream data processing jobs and/or downstream users. In this context, the SLA associated with the data processing job may indicate a time or another suitable parameter related to when the output needs to be delivered to the downstream data processing jobs and/or downstream users. For example, in cases where the upstream dependency is satisfied before the wait time has elapsed, the data processing job may be appropriately triggered, and the associated SLA may be satisfied. However, in cases where the upstream dependency is satisfied before the wait time has elapsed, existing workflow management systems typically fail the entire data processing job in order to trigger remediation functions to notify support personnel to communicate that there is a delay to the concerned downstream users and/or manually retrigger the failed data processing job to extend the life of the failed data processing job, which is a time consuming and manual activity that requires active involvement from support personnel (often during off-hours when support personnel may not be working or otherwise available to resolve the upstream dependency).

In some implementations, as described herein, an SLA management system may be configured to automate various support processes that relate to monitoring data processing jobs for SLA compliance, notifying appropriate users when an SLA breach is detected (e.g., to inform downstream users to expect a delay of when the results of a data processing job will be available and/or to inform support personnel to remedy any information technology infrastructure issues that may be causing the SLA breach and/or may be caused by the SLA breach). For example, in some implementations, a data processing system may be configured to execute a set of data processing jobs, and a workflow management system may be configured to monitor a status of the data processing jobs and write information to a designated storage location when a monitored data processing job is successfully completed. Accordingly, in some implementations, the information written to the designated storage location may be used to drive the SLA management system, which may check the designated storage location at a time when an SLA associated with a data processing job needs to be satisfied (e.g., the SLA may define a deadline for completing the data processing job to ensure that the data processing job produces the desired output by a time when the desired output is needed for a downstream dependency). In this way, in cases where there is an SLA breach (e.g., the workflow management system has not written information to the designated storage location by the time that the SLA needs to be satisfied), the SLA management system may send a notification to support personnel to report the SLA breach and/or may send a message to downstream users to indicate that there will be a delay in the availability of the output from the data processing job that breached the SLA without failing or otherwise terminating the data processing job. Furthermore, in some implementations, the SLA management system may generate one or more user interfaces to display detailed information related to the SLA compliance and/or SLA breach status of the monitored data processing jobs.

Accordingly, as described herein, the SLA management system may avoid a need to fail or terminate a data processing job that has breached an SLA because there may be no need to trigger a failure to inform support personnel that a data processing job failed to start or complete on time and because the SLA management system may automatically notify downstream users who may need to be made aware of delays in data availability without involving support personnel. Furthermore, as described herein, the SLA management system may run in a serverless environment that consumes a small amount of computing resources, which may enable scaling the SLA management system to manage large quantities of data processing jobs and/or support large numbers of applications (e.g., applications that integrate with the SLA management system). In addition, the SLA management system may utilize techniques that are applicable to any system or data processing job for which an SLA needs to be tracked, may support a configurable SLA (e.g., where a user can change the applicable SLA period as-needed without having access to a console associated with the data processing system where the data processing jobs are running or a change order that otherwise limits changing the SLA period). Furthermore, as described herein, the SLA management system may support machine learning techniques to build predictive algorithms to detect SLA failures or SLA breaches in advance (e.g., using status information as a feedback loop to predict data processing jobs that have a high failure probability, notify interested users in advance, and continuously optimize SLA periods to reduce an adverse impact associated with a failure to timely deliver data processing outputs).

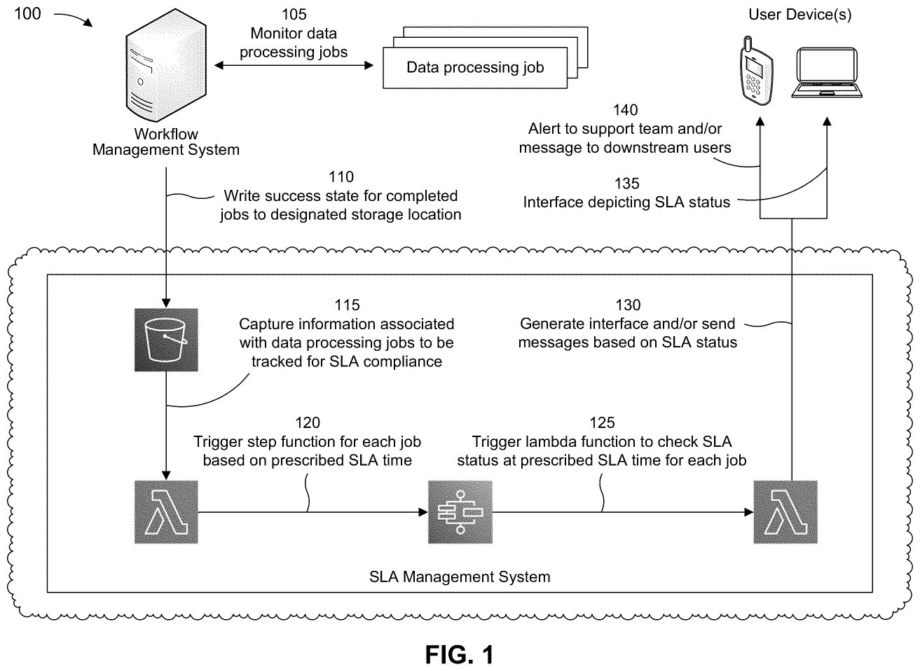

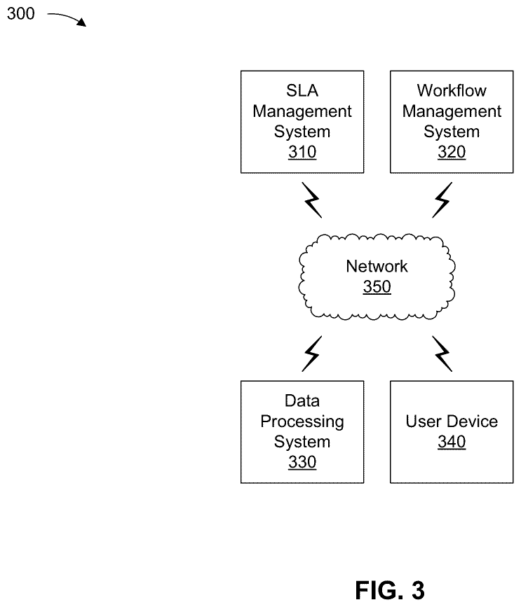

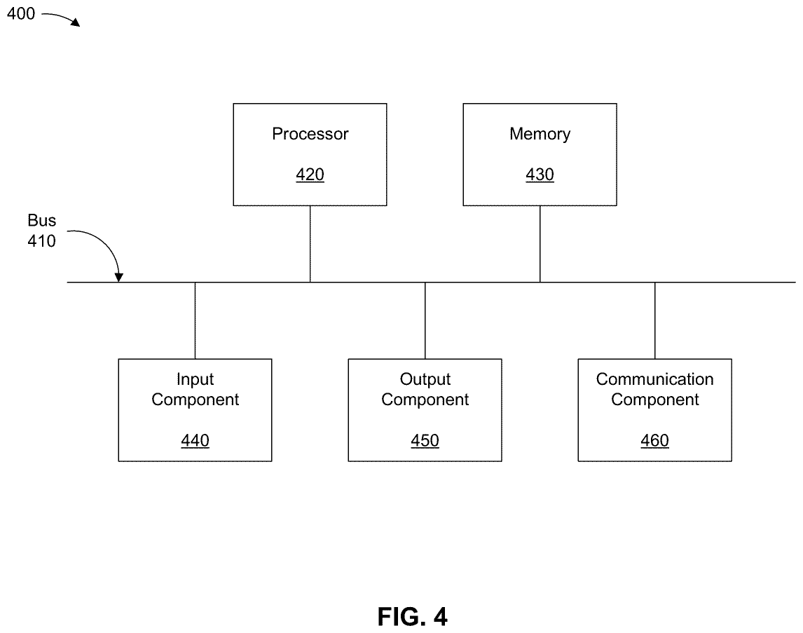

FIG. 1 is a diagram of an example implementation 100 associated with SLA management and breach detection. As shown in FIG. 1, example implementation 100 includes an SLA management system, a workflow management system, and one or more user devices. In some implementations, example implementation 100 may further include a data processing system (not explicitly shown in FIG. 1). The SLA management system, the workflow management system, the one or more user devices, and the data processing system are described in more detail in connection with FIG. 3 and FIG. 4.

As shown in FIG. 1, and by reference number 105, a workflow management system may be configured to monitor a set of data processing jobs that are scheduled to be executed in the data processing system. In some implementations, the data processing jobs monitored by the workflow management system may be configured to perform any suitable data processing function, such as data validation, data sorting, data summarization, data aggregation, data analysis, data reporting, and/or data classification, among other examples. For example, in some implementations, the data processing jobs that are executed in the data processing system and monitored by the workflow management system may include a set of extract, transform, load (ETL) jobs, where each ETL job may include constituent tasks to extract data records from a data source, transform the extracted data records into a target format, and load the transformed data records into a data sink. Furthermore, in some implementations, one or more of the constituent tasks may include one or more sub-tasks (e.g., the extract task, the transform task, and/or the load task may include one or more sub-tasks) and/or one or more ETL jobs may be nested within another ETL job and/or a group of ETL jobs (e.g., an ETL project) that includes multiple ETL jobs to be executed in a concurrent, sequential, and/or interleaved manner. For example, a particular ETL job or a group of ETL jobs may be configured with various settings associated with different constituent tasks and/or sub-tasks associated with the ETL job(s), and the settings that are configured for each ETL job (and/or other data processing jobs monitored by the workflow management system) may include an SLA associated with the ETL job and/or one or more intermediate stages (e.g., a constituent task) associated with the ETL job.

For example, in some implementations, the settings that are configured for the ETL jobs that are monitored by the workflow management system may include one or more connection settings to define parameters that the data processing system uses to connect to the data source (which may include one or more heterogeneous and/or homogeneous data sources), extraction settings to define queries, commands, and/or other parameters that the data processing system uses to extract data records from the data source, transformation settings to define specific transformation settings that the data processing system is to apply to data records extracted from the data source, lookup settings to define criteria to look up one or more values that correspond to a key in a lookup table that contains one or more key-value pairs, staging settings to prepare (e.g., buffer) transformed data records for loading into the data sink, destination settings to define parameters that the data processing system uses to connect to the data sink (which may include one or more data storage devices), and/or loading settings to define parameters used to load transformed data into the data sink.

Furthermore, in some implementations, when configuring a particular ETL job, group of ETL jobs, or other data processing job for which an SLA is to be tracked, the workflow management system or another suitable device may configure the SLA associated with the data processing job, which may define scheduling settings for executing the particular data processing job, group of data processing jobs, and/or different constituent tasks and/or sub-tasks associated with a data processing job or a group of data processing jobs. For example, in some implementations, the scheduling settings may configure one or more data processing jobs and/or constituent tasks to be executed on-demand, at a particular time, at periodic intervals, and/or when certain triggering criteria are satisfied (e.g., when available resources satisfy a threshold, when a data volume of data records to be extracted, transformed, and/or loaded satisfies a threshold, when a new data source or data sink is connected to the data processing system, and/or when anomalies are detected in the extracted, transformed, and/or loaded data, among other examples). Additionally, or alternatively, the scheduling settings may configure a data processing pipeline in which extraction, transformation, and/or loading tasks are executed. For example, in some implementations, scheduling settings may be configured to define upstream and/or downstream dependencies associated with different tasks that are performed within the data processing pipeline to extract, transform, and load data records (e.g., nested data processing jobs that cannot proceed until one or more data processing jobs that are earlier in the pipeline have completed) and/or tasks that can be executed in parallel once any preconditions are satisfied. Furthermore, each data processing pipeline, data processing job, or constituent task associated with a data processing pipeline or data processing job may be associated with a designated SLA that defines a time when the output from the data processing pipeline, job, or constituent task needs to be made available to satisfy a downstream dependency (e.g., a downstream data processing pipeline or job that operates on the output and/or one or more users that have a need to interact with or otherwise consume the output). For example, as described herein, the SLA may define an absolute time when the output from the data processing pipeline, job, or constituent task needs to be made available (e.g., a specific time of day) and/or a relative time when the output from the data processing pipeline, job, or constituent task needs to be made available (e.g., before a downstream dependency waiting on the output is triggered).

As further shown in FIG. 1, and by reference number 110, the workflow management system may be configured to write, to a designated storage location, information that indicates a success state for each data processing job that completes successfully. For example, in some implementations, the workflow management system may include a platform or may execute an application (e.g., Apache Airflow) that enables workflows (e.g., data processing jobs) to be programmatically authored, scheduled, and monitored. For example, in some implementations, the workflow management system can be used to author a workflow as a directed acyclic graph (DAG) that includes various tasks and/or sub-tasks, and the workflow management system may include a scheduler to execute the data processing job associated with an authored workflow using one or more arrays of computational resources (e.g., provided in the data processing system) while ensuring that all upstream and downstream dependencies are appropriately followed. Accordingly, the workflow management system may have access to detailed information related to the data processing jobs that are scheduled to execute in the data processing system, which can be used to monitor the progress of the data processing job (or any stage of the data processing job) and troubleshoot problems if and/or when needed. In this way, the workflow management system may be programmed or otherwise configured to determine whether and/or when a data processing job or a stage of a data processing job has completed successfully, and to write information that indicates a success state associated with each data processing job and/or each stage of a data processing job that completed successfully to the designated storage location. For example, in some implementations, the designated storage location may include a simple storage service (S3) bucket, which may include a cloud-based storage resource that is provided in an environment (e.g., a cloud infrastructure) hosting the SLA management system to provide object storage via a web services interface. Additionally, or alternatively, the workflow management system may be configured to write the information indicating the success states associated with the data processing jobs that complete successfully to a designated storage location provided in any suitable data repository.

As further shown in FIG. 1, and by reference number 115, the SLA management system may capture information associated with one or more data processing jobs to be tracked for SLA compliance. For example, to enforce the SLA associated with each data processing job and/or each stage of a data processing job that is tracked for SLA compliance, the SLA management system may be hosted as a serverless system in a cloud infrastructure and may be configured to check the designated storage location at appropriate times to verify whether information indicating a success state for a tracked data processing job and/or a tracked stage of a data processing job is present or otherwise available in the designated storage location at a time when the associated SLA needs to be satisfied (e.g., the SLA management system may check the designated storage location for the presence of the information indicating the success state for a tracked data processing job and/or a tracked stage of a data processing job at the time when the data processing job and/or stage of the data processing job needs to be complete in order to satisfy the associated SLA). Accordingly, as described herein, the SLA management system may determine that any data processing job and/or any stage of a data processing job that has a success state written to the designated storage location at the time that the SLA management system checks the designated storage location is in compliance with the associated SLA. On the other hand, the SLA management system may determine that any data processing job and/or any stage of a data processing job that does not have a success state written to the designated storage location at the time that the designated storage location is checked in breach of the associated SLA, in which case one or more remediation actions may be initiated (e.g., sending a pager alert to users on a support team and/or sending an email to downstream users).

For example, in some implementations, a first lambda function may be triggered at a scheduled time (e.g., at periodic intervals, such as daily at midnight or 2 am) to capture the information associated with the data processing jobs to be tracked for SLA compliance. In some implementations, the information associated with the data processing jobs to be tracked for SLA compliance may be obtained from the S3 bucket or other suitable data repository or storage location where the workflow management system writes the information to indicate the success state for a data processing job that has completed successfully. In some implementations, the first lambda function may include a serverless compute function that can run code when one or more configured events occur and automatically manage computing resources that the code requires (e.g., allocating processor, memory, storage, and/or other computing resources to the code run by the first lambda function when the one or more configured events have occurred). For example, the first lambda function may correspond to a container instance (e.g., an isolated user space instance) associated with a random access memory (RANI) allocation, an ephemeral storage allocation, and a configurable execution time (e.g., from 1 to 900 seconds), where the ephemeral storage remains locally available only for a duration of the first lambda function and is discarded after all tasks running on the first lambda function have completed. Furthermore, as described above, the first lambda function is generally triggered when one or more events occur (e.g., rather than being started or controlled directly). Each execution of the first lambda function is run in a new environment (e.g., a new container) such that access to an execution context from previous and/or subsequent runs of the first lambda function are not accessible during a current run, which makes each instance of the first lambda function stateless with all incoming and outgoing data being stored using resources external to the first lambda function.

Accordingly, in some implementations, the triggering event for the first lambda function may be the scheduled time for initiating SLA tracking for a set of data processing jobs being executed in a current SLA tracking interval. For example, as described herein, the first lambda function may be triggered daily at a particular time, weekly at a particular time, or at another suitable periodic intervals. In some implementations, after the SLA management system triggers the first lambda function, the first lambda function may be configured to iterate through the set of data processing jobs to be tracked for SLA compliance to capture the information associated with the set of data processing jobs to be tracked. For example, in some implementations, the workflow management system may store a configuration file or other suitable data that contains information related to each data processing job that is being executed in the data processing system in an S3 bucket or another suitable storage location external to a container corresponding to a current instance of the first lambda function. Accordingly, when the first lambda function is triggered, the first lambda function may iterate through the configuration file or other suitable data to capture relevant parameters associated with the data processing jobs to track for SLA compliance. For example, the parameters that are captured from the configuration file may include, for each tracked data processing job, a scheduled start time, an expected execution duration, one or more upstream dependencies (e.g., other data processing jobs or stages that need to complete before the data processing job can begin), one or more downstream dependencies (e.g., other data processing jobs, stages, and/or users that depend on completion of the data processing job), and an SLA compliance time. In general, the SLA compliance time may generally define a time when the data processing job needs to complete in order to satisfy the SLA associated with the data processing job, whereby the SLA compliance time may essentially provide a deadline for completion of the associated data processing job.

As further shown in FIG. 1, and by reference number 120, the first lambda function may trigger a step function for each data processing job tracked for SLA compliance. For example, the first lambda function may obtain or generate a payload for each data processing job tracked for SLA compliance, where the payload may include an SLA field that indicates a time when the SLA associated with the data processing job needs to be satisfied (e.g., the completion deadline for the associated data processing job). In some implementations, the step functions that are triggered for each data processing job may correspond to serverless orchestration services based on state machines and tasks, where a state machine generally corresponds to a workflow, a task is a state in a workflow that represents a single unit of work that another function (e.g., a lambda function) performs, and each step in a workflow corresponds to a state. Accordingly, the step functions can be used to ensure that the SLA management system runs a series of functions in a particular order. Furthermore, the step functions are able to be configured with a wait state that defines a period of time, after which the step functions trigger another function (e.g., a second lambda function to check the SLA status for an associated data processing job). For example, when a step function associated with a data processing job is triggered, the step function may be configured with a wait time that is based on the time when the SLA for the associated data processing job needs to be satisfied. For example, if the first lambda function is triggered at midnight and identifies a first data processing job with an SLA compliance time of 4 am and a second data processing job with an SLA compliance time of 6 am, the first lambda function may trigger a first step function for the first data processing job with a wait time of 4 hours and a second step function for the second data processing job with a wait time of 6 hours.

Accordingly, as described herein, the first lambda function may generally iterate through the set of data processing jobs to be tracked for SLA compliance, determine a time when the SLA for each data processing job needs to be satisfied, and trigger a step function for each data processing job with a wait time that is based on (e.g., equal to a difference between) the time when the SLA for each data processing job needs to be satisfied and the time when the first lambda function is executed. For example, the first lambda function may pass the payload to each step function that is triggered for a corresponding data processing job, where the payload includes the SLA field indicating the time when the associated SLA needs to be satisfied. In some implementations, each step function triggered by the first lambda function may then enter a dormant (wait) state for the duration of the wait time.

As further shown in FIG. 1, and by reference number 125, each step function triggered by the first lambda function may enter the dormant (wait) state for the duration of the wait time for the respective step function, after which the step function triggers a second lambda function to check the SLA status of the associated data processing job. For example, in some implementations, the wait time associated with a step function may be configured to elapse at the time that the SLA of the associated data processing job needs to be satisfied, whereby the step function associated with the data processing job may trigger the second lambda function to check the SLA status of the associated data processing job when the wait time associated with the step function has elapsed. In some implementations, the second lambda function may then determine whether the corresponding data processing job has satisfied the SLA (e.g., completed before the deadline) or breached the SLA (e.g., has yet to successfully complete). For example, as described above, the workflow management system that monitors the status of the data processing jobs may be configured to write information that indicates a success state for each data processing job that completes successfully to a designated storage location (e.g., an S3 bucket).

Accordingly, at the time that the second lambda function is triggered for a particular data processing job, the second lambda function may determine whether the associated data processing job has satisfied or breached the associated SLA based on whether information that indicates a success state for the data processing job is present in the designated storage location. In particular, the second lambda function may determine that the associated data processing job has satisfied the SLA based on information indicating a success state for the data processing job being present in the designated storage location when the second lambda function is triggered. Alternatively, the second lambda function may determine that the data processing job breached the SLA based on information that indicates a success state for the data processing job being absent in the designated storage location when the second lambda function is triggered. In other words, the presence or absence of the success state information for a data processing job may indicate whether the data processing job completed or failed to complete by the expected deadline, which in turn may indicate whether the data processing job is in compliance with or in breach of the associated SLA.

As further shown in FIG. 1, and by reference number 130, the SLA management system may then generate a user interface and/or send one or more messages based on the SLA status (e.g., compliance or breach) for the set of data processing jobs being tracked for SLA compliance. For example, as shown by reference number 135, the user interface may provide a visualization that may be displayed on a user device to depict information related to the various data processing jobs being tracked for SLA compliance. For example, in some implementations, the user interface may indicate information such as how many data processing jobs are currently delayed (e.g., in breach of an SLA), how many data processing jobs have completed successfully (e.g., in compliance with an SLA), which data processing jobs are delayed due to one or more upstream dependencies, and/or which downstream data processing jobs and/or users are impacted by a delayed data processing job, among other examples. Furthermore, in some implementations, the SLA management system may maintain a record of the SLA compliance and SLA breach information for the various data processing jobs, which may indicate data processing jobs that have historically satisfied and/or historically failed to satisfy associated SLAs. Accordingly, in some implementations, the user interface may provide functionality that enables the user device to query or otherwise retrieve information related to current and/or historical SLA compliance and/or SLA breach information, which may be useful to identify patterns, trends, or other information associated with the tracked SLA status information. In this way, the user interface may provide support personnel or other interested users who may be monitoring the data processing jobs with visibility into all of the data processing jobs currently being tracked for SLA compliance and/or the data processing jobs historically tracked for SLA compliance.

Additionally, or alternatively, as shown by reference number 140, the SLA management system may send one or more messages based on one or more data processing jobs that are determined to be associated with an SLA breach (e.g., information indicating the success state of the one or more data processing jobs was absent from the designated storage location at the time that the second lambda function was triggered, indicating that the one or more data processing jobs failed to complete before the associated deadlines). For example, in some implementations, the one or more messages may include a pager alert associated with an incident response platform for information technology departments (e.g., PagerDuty or another suitable platform). For example, the pager alert may take the form of a text message, a notification, an audible alert, and/or any suitable combination thereof, and may generally include information related to the one or more data processing jobs that are associated with an SLA breach (e.g., identifying the applicable data processing job(s), the time(s) when the data processing job(s) needed to complete to satisfy the associated SLA(s), or the like). Additionally, or alternatively, in cases where the support personnel does not respond to the pager alert, the SLA management system may initiate a voice call to the support personnel to alert the support personnel about the SLA breach(es). Additionally, or alternatively, the one or more messages may include email messages, text messages, instant messages, or other suitable messages that are sent to downstream users that may have a need to consume or otherwise interact with the results of a data processing job that is associated with an SLA breach. For example, in some implementations, the messages sent to the downstream users may indicate there will be a delay in when the results of the data processing job will become available, an estimated time when the results of the data processing job will become available, and/or other suitable information.

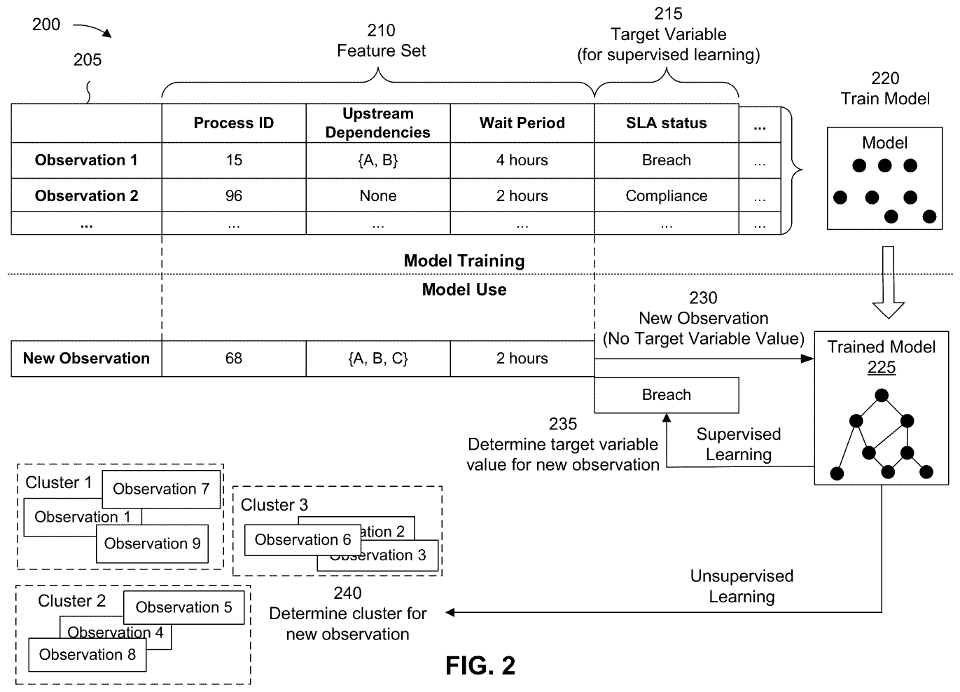

Furthermore, in some implementations, the SLA management system may be configured to use machine learning techniques to predict whether one or more data processing jobs will satisfy or breach an associated SLA in advance (e.g., prior to the wait period of the step function elapsing). For example, as described above, the SLA management system may maintain a historical record of the data processing jobs that are determined to satisfy associated SLAs and the data processing jobs that are determined to have breached associated SLAs based on the presence or absence of success state information at the time that the SLA(s) are required to be satisfied. In some implementations, the historical record may be used to drive the user interface that enables a user device to display, query, or otherwise visualize the SLA status information. Furthermore, in some implementations, the historical record may be used to train one or more machine learning models to predict, in advance of the prescribed SLA time associated with a data processing job, a probability of the data processing job satisfying and/or breaching the associated SLA (e.g., using techniques described in further detail below with reference to FIG. 2). For example, the one or more machine learning models may be trained to recognize patterns and/or trends in the data processing jobs that have historically satisfied respective SLAs and the data processing jobs that have historically failed to satisfy respective SLAs (e.g., upstream dependencies that tend to cause SLA breaches for downstream data processing jobs).

Accordingly, the one or more machine learning models may be used to identify one or more data processing jobs that are predicted to have a high probability of failing to satisfy the associated SLA prior to the time when the second lambda function is triggered to check whether the one or more data processing jobs actually satisfied or breached the associated SLA. In this way, the SLA management system may send one or more alerts, notifications, or other messages to interested users (e.g., support personnel or downstream consumers of the data processing results) to indicate that an SLA breach is possible or probable prior to the time when the SLA needs to be satisfied. In this way, support personnel may proactively attempt to remedy any information technology infrastructure issues to avoid the potential SLA breach and/or downstream consumers may know to expect a delay prior to the time when the results of the data processing jobs are expected to be available.

Furthermore, in some implementations, the predictions that are made using the one or more machine learning models may be used as a feedback loop to optimize one or more operational parameters and/or accuracy of the one or more machine learning models. For example, the predictions may be used to adjust the SLA periods to reduce the occurrences of SLA breaches and/or the impact on downstream users (e.g., extending an SLA compliance time for data processing jobs that have historically breached an SLA and/or shortening the SLA compliance time for data processing jobs that have historically completed on time or early). Additionally, or alternatively, when the second lambda function is triggered to check the SLA compliance for a data processing job at the time that the associated SLA needs to be satisfied, the actual SLA compliance or SLA breach information may be compared to a predicted SLA status for the data processing job to improve accuracy of the machine learning models (e.g., reinforcing one or more weights used in the predictive algorithms when the predicted SLA status matches the actual SLA status for one or more data processing jobs or reducing the value of one or more weights used in the predictive algorithms when the predicted SLA status differs from the actual SLA status for one or more data processing jobs).

As indicated above, FIG. 1 is provided as an example. Other examples may differ from what is described with regard to FIG. 1.

FIG. 2 is a diagram illustrating an example 200 of training and using a machine learning model in connection with SLA management and breach detection. The machine learning model training and usage described herein may be performed using a machine learning system. The machine learning system may include or may be included in a computing device, a server, a cloud computing environment, or the like, such as the SLA management system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a data processing system configured to execute one or more data processing jobs that are tracked for SLA compliance, a workflow management system configured to monitor a status of the data processing jobs that are tracked for SLA compliance, and/or an SLA management system configured to track SLA compliance for the data processing jobs executed by the data management system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the data processing system, the workflow management system, and/or the SLA management system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a process identifier, a second feature of upstream dependencies, a third feature of a wait period, and so on. As shown, for a first observation, the first feature may have a value of 15, the second feature may have a value of {A,B} (e.g., indicating an upstream dependency on data processing jobs A and B), the third feature may have a value of 4 hours, and so on. These features and feature values are provided as examples, and may differ in other examples. For example, the feature set may include one or more of the following features: downstream dependencies, SLA period, expected duration, and/or SLA breach rate, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is SLA status, which has a value of breach for the first observation (e.g., based on unavailability of information indicating a success state for a data processing job associated with process identifier 15 after the 4 hour wait period, which may potentially be caused by the upstream dependency on data processing job A and/or data processing job B).

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, in some implementations, the machine learning model may be used to predict one or more data processing jobs that have a high failure probability (e.g., are likely to breach an SLA) and/or one or more data processing jobs that have a low failure probability (e.g., are likely to satisfy the SLA), among other examples. After training, the machine learning system may store the machine learning model as a trained machine learning model 225 to be used to analyze new observations.

As an example, the machine learning system may obtain training data for the set of observations based on status information associated with one or more data processing jobs that are executed in a data processing system and monitored by a workflow management system that writes information to indicate a success state associated with a data processing job that successfully completes to a designated storage location (e.g., an S3 bucket or another suitable repository or storage location accessible to the SLA management system). In this example, the machine learning system may record information related to each data processing job that is tracked for SLA compliance, and the feature set(s) included in each observation may be derived from parameters associated with an execution instance of the data processing job.

As shown by reference number 230, the machine learning system may apply the trained machine learning model 225 to a new observation, such as by receiving a new observation and inputting the new observation to the trained machine learning model 225. As shown, the new observation may include a first feature indicating a process identifier of a data processing job tracked for SLA compliance, a second feature indicating upstream dependencies of the data processing job tracked for SLA compliance, a third feature indicating a wait period of the data processing job tracked for SLA compliance, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of breach for the target variable of SLA status for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to adjust the SLA period or wait time associated with the data processing job or a recommendation to investigate potential information technology infrastructure issues or other factors that may be causing the SLA breach due to an upstream dependency. The first automated action may include, for example, sending a pager alert or another suitable message to support personnel to inform the support personnel about the SLA breach that is predicted to occur and/or sending a message to one or more downstream users that may need to interact with or otherwise consume the output of the data processing job to inform the downstream users to expect a delay in when data output by the data processing job is likely to become available.

As another example, if the machine learning system were to predict a value of compliance for the target variable of SLA status, then the machine learning system may provide a second (e.g., different) recommendation (e.g., a recommendation to evaluate factors that are leading to the data processing job successfully completing in a timely manner) and/or may perform or cause performance of a second (e.g., different) automated action (e.g., generating a user interface that displays metrics or other analytics associated with the data processing jobs that are tracked for SLA compliance).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., data processing jobs that have breached an SLA), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., data processing jobs that are in compliance with an associated SLA), then the machine learning system may provide a second (e.g., different) recommendation (e.g., the second recommendation described above) and/or may perform or cause performance of a second (e.g., different) automated action (e.g., the second automated action described above).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include actual results associated with various data processing jobs that are tracked for SLA compliance and/or examples where the predicted SLA status for various data processing jobs that are tracked for SLA compliance matched and/or differed from the actual SLA compliance results.

In this way, the machine learning system may apply a rigorous and automated process to predict a probability that a data processing job will satisfy or breach an SLA associated with the data processing job. The machine learning system may enable recognition and/or identification of tens, hundreds, thousands, or millions of features and/or feature values for tens, hundreds, thousands, or millions of observations, thereby increasing accuracy and consistency and reducing delay associated with predicting whether a data processing job will satisfy or breach an associated SLA relative to requiring computing resources to be allocated for tens, hundreds, or thousands of operators to manually detect SLA compliance and/or SLA breaches using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an SLA management system 310, a workflow management system 320, a data processing system 330, a user device 340, and a network 350. Devices of environment 300 may interconnect via wired connections, wireless connections, or a combination of wired and wireless connections.

The SLA management system 310 may include one or more devices capable of receiving, generating, storing, processing, providing, and/or routing information associated with SLA management and breach detection for one or more data processing jobs executed in the data processing system 330, as described elsewhere herein. The SLA management system 310 may include a communication device and/or a computing device. For example, the SLA management system 310 may include a server, such as an application server, a client server, a web server, a database server, a host server, a proxy server, a virtual server (e.g., executing on computing hardware), or a server in a cloud computing system. In some implementations, the SLA management system 310 may include computing hardware used in a cloud computing environment.

The workflow management system 320 may include one or more devices capable of receiving, generating, storing, processing, providing, and/or routing information associated with one or more jobs that are executed in the data processing system 330 and tracked for SLA management and breach detection, as described elsewhere herein. The workflow management system 320 may include a communication device and/or a computing device. For example, the workflow management system 320 may include a server, such as an application server, a client server, a web server, a database server, a host server, a proxy server, a virtual server (e.g., executing on computing hardware), or a server in a cloud computing system. In some implementations, the workflow management system 320 may include computing hardware used in a cloud computing environment.

The data processing system 330 may include one or more devices capable of receiving, generating, storing, processing, providing, and/or routing information associated with one or more jobs that are tracked for SLA management and breach detection, as described elsewhere herein. The data processing system 330 may include a communication device and/or a computing device. For example, the data processing system 330 may include a server, such as an application server, a client server, a web server, a database server, a host server, a proxy server, a virtual server (e.g., executing on computing hardware), or a server in a cloud computing system. In some implementations, the data processing system 330 may include computing hardware used in a cloud computing environment.

The user device 340 may include one or more devices capable of receiving, generating, storing, processing, and/or providing information associated with SLA management and breach detection for one or more data processing jobs executed in the data processing system 330, as described elsewhere herein. The user device 340 may include a communication device and/or a computing device. For example, the user device 340 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with SLA management and breach detection. The device 400 may correspond to the SLA management system, the workflow management system, the data processing system, and/or the user device. In some implementations, the SLA management system, the workflow management system, the data processing system, and/or the user device may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include RAM, read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

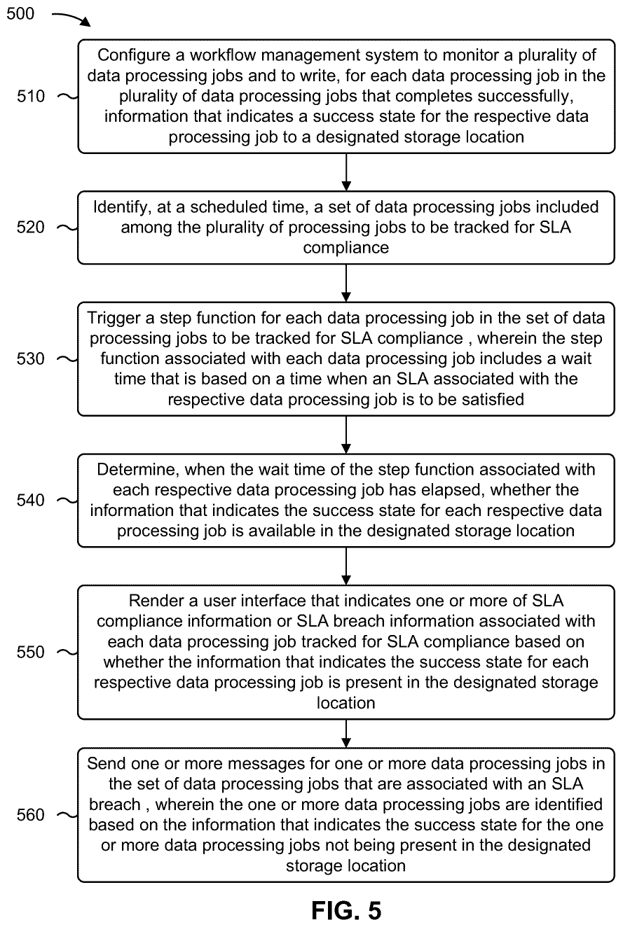

FIG. 5 is a flowchart of an example process 500 associated with SLA management and breach detection. In some implementations, one or more process blocks of FIG. 5 may be performed by the SLA management system 310. In some implementations, one or more process blocks of FIG. 5 may be performed by another device or a group of devices separate from or including the SLA management system 310, such as the workflow management system 320, the data processing system 330, and/or the user device 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include configuring a workflow management system to monitor a plurality of data processing jobs and to write, for each data processing job in the plurality of data processing jobs that completes successfully, information that indicates a success state for the respective data processing job to a designated storage location (block 510). For example, the SLA management system 310 (e.g., using processor 420 and/or memory 430) may configure a workflow management system to monitor a plurality of data processing jobs and to write, for each data processing job in the plurality of data processing jobs that completes successfully, information that indicates a success state for the respective data processing job to a designated storage location, as described above in connection with reference numbers 105 and 110 of FIG. 1. As an example, a workflow management system may be configured to monitor a status of one or more ETL job executed in a data processing system and to write information to a designated storage location (e.g., an S3 bucket) when a monitored ETL job successfully completes to indicate a success state associated with the monitored ETL job.

As further shown in FIG. 5, process 500 may include identifying, at a scheduled time, a set of data processing jobs included among the plurality of processing jobs to be tracked for SLA compliance (block 520). For example, the SLA management system 310 (e.g., using processor 420 and/or memory 430) may identify, at a scheduled time, a set of data processing jobs included among the plurality of processing jobs to be tracked for SLA compliance, as described above in connection with reference number 115 of FIG. 1. As an example, at a scheduled time (e.g., daily at a particular time, such as 12 am), an SLA management system may be configured to iterate through a list of one or more processes, such as ETL jobs, for which an SLA is to be tracked, and may capture information associated with each process for which the SLA is to be tracked.

As further shown in FIG. 5, process 500 may include triggering a step function for each data processing job in the set of data processing jobs to be tracked for SLA compliance (block 530). For example, the SLA management system 310 (e.g., using processor 420 and/or memory 430) may trigger a step function for each data processing job in the set of data processing jobs to be tracked for SLA compliance, as described above in connection with reference number 120 of FIG. 1. In some implementations, the step function associated with each data processing job includes a wait time that is based on a time when an SLA associated with the respective data processing job is to be satisfied. As an example, for each data processing job (e.g., ETL job) for which an SLA is to be tracked, the SLA management system may trigger a step function having a wait time that is based on the time when the SLA associated with the data processing job needs to be satisfied. For example, in a scenario where the SLA management system iterates through the set of data processing jobs to be tracked at 12 am daily, a step function that is triggered for a data processing job that is scheduled to complete at 4 am may have a wait time of 4 hours.

As further shown in FIG. 5, process 500 may include determining, when the wait time of the step function associated with each respective data processing job has elapsed, whether the information that indicates the success state for each respective data processing job is available in the designated storage location (block 540). For example, the SLA management system 310 (e.g., using processor 420 and/or memory 430) may determine, when the wait time of the step function associated with each respective data processing job has elapsed, whether the information that indicates the success state for each respective data processing job is available in the designated storage location, as described above in connection with reference number 125 of FIG. 1. As an example, a data processing job may be associated with an SLA that specifies that the data processing job must complete by a designated time, and the wait time of the function may be configured such that information indicating that the data processing job has completed successfully should be present in the designated storage location if the data processing job completed on time (e.g., during the wait time of the step function). Accordingly, when the wait time of the step function has elapsed, the SLA management system may check the designated storage location where information indicating a success state for data processing jobs that completed successfully is written to determine whether the data processing job successfully completed on time (e.g., by the time that the SLA needs to be satisfied).

As further shown in FIG. 5, process 500 may include rendering a user interface that indicates one or more of SLA compliance information or SLA breach information associated with each data processing job tracked for SLA compliance based on whether the information that indicates the success state for each respective data processing job is present in the designated storage location (block 550). For example, the SLA management system 310 (e.g., using processor 420 and/or memory 430) may render a user interface that indicates one or more of SLA compliance information or SLA breach information associated with each data processing job tracked for SLA compliance based on whether the information that indicates the success state for each respective data processing job is present in the designated storage location, as described above in connection with reference numbers 130 and 135 of FIG. 1. As an example, the SLA management system may track information related to whether each data processing job tracked for SLA compliance completed successfully, breached an SLA, or the like, and the user interface may enable one or more user devices to display one or more dashboards or other analytics interfaces that depict the status of each data processing job. (e.g., to provide visibility into data processing jobs that are currently delayed, completed successfully, and/or waiting on an upstream dependency, among other examples).

As further shown in FIG. 5, process 500 may include sending one or more messages for one or more data processing jobs in the set of data processing jobs that are associated with an SLA breach (block 560). For example, the SLA management system 310 (e.g., using processor 420, memory 430, and/or communication component 460) may send one or more messages for one or more data processing jobs in the set of data processing jobs that are associated with an SLA breach, as described above in connection with reference numbers 130 and 140 of FIG. 1. In some implementations, the one or more data processing jobs are identified based on the information that indicates the success state for the one or more data processing jobs not being present in the designated storage location. As an example, when an SLA breach is detected or predicted to occur, the SLA management system may send a notification (e.g., a pager alert, such as a text message or an instant message) to support personnel to notify the support personnel of the SLA breach and the potential need to remedy information technology infrastructure issues that may have caused the SLA breach. Additionally, or alternatively, the SLA management system may send a message (e.g., an email or other suitable message) to one or more downstream users that interact with the output from the data processing job(s) associated with the SLA breach(es) to inform the downstream user(s) to expect a delay with respect to when the output from the data processing job(s) associated with the SLA breach(es) will be available.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIG. 1. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for service level agreement (SLA) management and breach detection, the system comprising:
one or more memories; and
one or more processors, communicatively coupled to the one or more memories, configured to:
configure a workflow management system to monitor a plurality of data processing jobs and to write, for each data processing job in the plurality of data processing jobs that completes successfully, information that indicates a success state for the respective data processing job to a designated storage location;
identify, at a scheduled time, a set of data processing jobs included among the plurality of data processing jobs to be tracked for SLA compliance;
trigger a step function for each data processing job in the set of data processing jobs to be tracked for SLA compliance,
wherein the step function associated with each data processing job includes a wait time that is based on a time when an SLA associated with the respective data processing job is to be satisfied;
determine, when the wait time of the step function associated with each respective data processing job has elapsed, whether the information that indicates the success state for each respective data processing job is available in the designated storage location;
render a user interface that indicates one or more of SLA compliance information or SLA breach information associated with each data processing job tracked for SLA compliance based on whether the information that indicates the success state for each respective data processing job is present in the designated storage location; and
send one or more messages for one or more data processing jobs in the set of data processing jobs that are associated with an SLA breach,
wherein the one or more data processing jobs are identified based on the information that indicates the success state for the one or more data processing jobs not being present in the designated storage location.

2. The system of claim 1, wherein the SLA associated with each respective data processing job defines a deadline associated with the respective data processing job.

3. The system of claim 1, wherein the one or more processors, to trigger the step function for each data processing job to be tracked for SLA compliance, are further configured to:
pass, to the step function associated with each data processing job to be tracked for SLA compliance, a payload that includes an SLA field to indicate the time when the SLA associated with the respective data processing job is to be satisfied.

4. The system of claim 3, wherein the wait time associated with the step function for each respective data processing job is based on the scheduled time when the set of data processing jobs to be tracked for SLA compliance is identified and a value of the SLA field.

5. The system of claim 1, wherein the one or more messages include one or more alerts or notifications that are sent to one or more users on a support team supporting the one or more data processing jobs associated with the SLA breach.

6. The system of claim 1, wherein the one or more messages are sent to one or more downstream users that interact with results of the one or more data processing jobs associated with the SLA breach to inform the one or more downstream users that the results of the one or more data processing jobs associated with the SLA breach are delayed.

7. The system of claim 1, wherein the one or more processors are further configured to:
maintain a record of the SLA compliance information and the SLA breach information,
wherein the SLA compliance information indicates data processing jobs that have historically satisfied respective SLAs associated with the data processing jobs, and
wherein the SLA breach information indicates data processing jobs that have historically failed to satisfy the SLA associated with the data processing jobs;
identify one or more data processing jobs that are predicted to have a high probability of failing to satisfy the SLA associated with the one or more data processing jobs based on the record of the SLA compliance information and the SLA breach information; and
send one or more alerts or notifications to indicate that the one or more data processing jobs are predicted to have the high probability of failing to satisfy the SLA,
wherein the one or more alerts or notifications are sent prior to the time when the respective SLAs associated with the one or more data processing jobs are to be satisfied.

8. The system of claim 7, wherein the one or more processors are further configured to:
adjust the SLA for the one or more data processing jobs that are predicted to have the high probability of failing to satisfy the SLA.

9. The system of claim 7, wherein the one or more data processing jobs predicted to have the high probability of failing to satisfy the SLA are identified using a machine learning model trained using the record of the SLA compliance information and the SLA breach information.

10. The system of claim 1, wherein each data processing job included in the set of data processing jobs tracked for SLA compliance is an extract, transform, load (ETL) job.

11. A method for tracking service level agreement (SLA) compliance, comprising:
identifying, by an SLA management system at a scheduled time, a set of data processing jobs to be tracked for SLA compliance;
triggering, by the SLA management system, a step function for each data processing job in the set of data processing jobs to be tracked for SLA compliance,
wherein the step function associated with each data processing job includes a wait time that is based on the scheduled time and a time when an SLA associated with the respective data processing job is to be satisfied;
determining, by the SLA management system when the wait time of the step function associated with each respective data processing job has elapsed, whether information that indicates a success state for each respective data processing job is available in a designated storage location; and
sending, by the SLA management system, one or more messages for one or more data processing jobs in the set of data processing jobs that are associated with an SLA breach,
wherein the one or more data processing jobs are identified based on the information that indicates the success state for the one or more data processing jobs not being present in the designated storage location.

12. The method of claim 11, wherein the one or more messages include one or more alerts or notifications that are sent to one or more users on a support team supporting the one or more data processing jobs associated with the SLA breach.

13. The method of claim 11, wherein the one or more messages are sent to one or more downstream users that interact with results of the one or more data processing jobs associated with the SLA breach to inform the one or more downstream users that the results of the one or more data processing jobs associated with the SLA breach are delayed.

14. The method of claim 11, further comprising:
maintaining a record of SLA compliance information and SLA breach information,
wherein the SLA compliance information indicates data processing jobs that have historically satisfied the SLA associated with the data processing jobs, and
wherein the SLA breach information indicates data processing jobs that have historically failed to satisfy the SLA associated with the data processing jobs;
identifying one or more data processing jobs that are predicted to have a high probability of failing to satisfy the SLA associated with the one or more data processing jobs based on the record of the SLA compliance information and the SLA breach information; and
sending one or more alerts or notifications to indicate that the one or more data processing jobs are predicted to have the high probability of failing to satisfy the SLA,
wherein the one or more alerts or notifications are sent prior to the time when the respective SLAs associated with the one or more data processing jobs are to be satisfied.

15. The method of claim 14, further comprising:
adjusting the SLA for the one or more data processing jobs that are predicted to have the high probability of failing to satisfy the SLA.

16. A non-transitory computer-readable medium storing a set of instructions, the set of instructions comprising:
one or more instructions that, when executed by one or more processors of a SLA management system, cause the SLA management system to:
identify, at a scheduled time, a set of data processing jobs to be tracked for SLA compliance;
trigger a step function for each data processing job in the set of data processing jobs to be tracked for SLA compliance,
wherein the step function associated with each data processing job includes a wait time that is based on a time when an SLA associated with the respective data processing job is to be satisfied;
determine, when the wait time of the step function associated with each respective data processing job has elapsed, whether information that indicates a success state for each respective data processing job is available in a designated storage location; and
render a user interface that indicates one or more of SLA compliance information or SLA breach information associated with each data processing job tracked for SLA compliance based on whether the information that indicates the success state for each respective data processing job is present in the designated storage location.

17. The non-transitory computer-readable medium of claim 16, wherein the SLA associated with each respective data processing job defines a deadline associated with the respective data processing job.

18. The non-transitory computer-readable medium of claim 16, wherein the one or more instructions, that cause the SLA management system to trigger the step function for each data processing job to be tracked for SLA compliance, cause the SLA management system to:
pass, to the step function associated with each data processing job to be tracked for SLA compliance, a payload that includes an SLA field to indicate the time when the SLA associated with the respective data processing job is to be satisfied.

19. The non-transitory computer-readable medium of claim 18, wherein the wait time associated with the step function for each respective data processing job is based on the scheduled time when the set of data processing jobs to be tracked for SLA compliance is identified and a value of the SLA field.

20. The non-transitory computer-readable medium of claim 16, wherein the one or more instructions further cause the SLA management system to:
maintain a record of the SLA compliance information and the SLA breach information,
wherein the SLA compliance information indicates data processing jobs that have historically satisfied the SLA associated with the data processing jobs, and
wherein the SLA breach information indicates data processing jobs that have historically failed to satisfy the SLA associated with the data processing jobs;
identify one or more data processing jobs that are predicted to have a high probability of failing to satisfy the SLA associated with the one or more data processing jobs based on the record of the SLA compliance information and the SLA breach information; and
send one or more alerts or notifications to indicate that the one or more data processing jobs are predicted to have the high probability of failing to satisfy the SLA,
wherein the one or more alerts or notifications are sent prior to the time when the respective SLAs associated with the one or more data processing jobs are to be satisfied.
